(19) United States
(12) Patent Application Publication
(10) Pub. No.: US 2026/0361343 A1
(43) Pub. Date: Nov. 12, 2026

(54) RECONFIGURABLE INTELLIGENT SURFACE WITH UNIT CELL FAILURE DETECTION

(71) Applicant: British Telecommunications Public Limited Company, London (GB)

(72) Inventors: Fraser BURTON, London (GB); Malcolm HUBERT, London (GB); Aaron WALKER, London (GB)

(21) Appl. No.: 19/471,922

(22) PCT Filed: Mar. 7, 2024
(86) PCT No.: PCT/EP2024/056060

§ 371 Date: Oct. 2, 2025

(30) Foreign Application Priority Data
Apr. 4, 2023 (EP) 23166607.4

(51) Int. Cl. H04B 7/04; H01Q 15/00; H04B 17/40

(52) U.S. Cl. CPC H04B 7/04013; H01Q 15/0066; H04B 17/409

(57) ABSTRACT

A computer implemented method of detecting failure in a reconfigurable intelligent surface, RIS, that can be conformed to a non-planar surface, the RIS comprising a plurality of RIS unit cells, the method comprising, by one or more processors: determining an initial value for a first electrical property of each of the plurality of RIS unit cells, the first electrical property being indicative of the change in phase of reflected electromagnetic waves received at the surface of the RIS unit cell; subsequently measuring the electrical property of each of the plurality of RIS unit cells; and determining a failure in one or more unit cells of the plurality of RIS unit cells based on a comparison between the measured electrical property and the initial value of the first electrical property.

### PRIORITY CLAIM

The present application is a National Phase Entry of PCT Application No. PCT/EP2024/056060, filed Mar. 7, 2024, which claims priority from EP Application No. 23166607.4, filed Apr. 4, 2023, each of which is hereby fully incorporated herein by reference.

### TECHNICAL FIELD

The present disclosure relates to detecting failure in a reconfigurable intelligent surface (RIS). In particular, the present disclosure relates to methods of detecting failure in a RIS that can be conformed to a non-planar surface and a corresponding RIS.

### BACKGROUND

A Reconfigurable Intelligent Surface (RIS) is an inexpensive adaptive thin composite material sheet, which can cover parts of walls, buildings, ceilings, etc., and is capable of modifying radio waves impinging upon it, or passing through it, in ways that can be programmed and controlled by using external stimuli. This technology has been described by a wide variety of names including: large intelligent surfaces, reconfigurable reflectarrays, reconfigurable intelligent surfaces, intelligent reflecting surfaces, software-controlled metasurfaces, and programmable surfaces.

A RIS used for wireless radio frequency (RF) communications is usually positioned between a transmitter and a receiver. The RIS is generally placed either mid-way between the transmitter and the receiver to overcome a blocked line-of-sight, or alternatively it can be placed close to either the transmitter or receiver in order to minimize path-loss. The RIS can operate in reflection and may comprise a rigid array of diode-controlled unit cells mounted on printed circuit boards connected to a separate controller. The unit cell separation determines the RF frequency of operation and the controller determines the reflective characteristics of the surface. The RIS can also operate in transmission using transparent unit cells and the unit cells themselves do not need to be diode-based but can use a wide range of metasurfaces. Generally, therefore, a RIS operates to produce a change in phase of electromagnetic waves incident on the RIS unit cell or the electromagnetic waves may pass through the RIS and their phases are altered during passage through.

### SUMMARY

Generally the disclosure relates to a Reconfigurable Intelligent Surface (RIS) having a plurality of unit cells and a sensor for detecting failure of a unit cell.

According to a first aspect, a computer implemented method is provided of detecting failure in a reconfigurable intelligent surface (RIS) that can be conformed to a non-planar surface, the RIS comprising a plurality of RIS unit cells. The method comprises, by one or more processors: determining an initial value for a first electrical property of each of the plurality of RIS unit cells, the first electrical property being indicative of the change in phase of electromagnetic waves received at the RIS unit cell; subsequently measuring the electrical property of each of the plurality of RIS unit cells; and determining a failure in one or more unit cells of the plurality of RIS unit cells based on a comparison between the measured electrical property and the initial value of the first electrical property.

Optionally the first electrical property may be indicative of the change in phase of reflected electromagnetic waves incident on the surface of the RIS unit cell. Alternatively, for a transmissive RIS, it may be indicative of the change in phase of electromagnetic waves passing through the RIS unit cell.

Optionally, additional (e.g. second and, optionally, further) different electrical properties of each of the plurality of RIS unit cells can be determined, the additional electrical properties each also being indicative of the change in phase of electromagnetic waves received at the RIS unit cell. These multiple electrical properties of the RIS can be measured and combined, using weightings for each property, to derive a value indicative of the change in phase of electromagnetic waves received at the RIS unit cell. Such a combined value may be more accurate than measuring a single value.

Optionally the RIS may be configured to operate at radio frequency (RF).

Optionally determining an initial value for the first electrical property of the plurality of RIS unit cells is based on a measurement of the first electrical property over time in response to an applied test voltage.

Optionally the first electrical property is an electrical impedance, capacitance, resistance or inductance of the RIS unit cell. Where the electrical property is a capacitance, optionally the capacitance value is in the range of 1 pF to 100 pF.

Optionally the RIS is flexible and has a reconfigurable and conformal shape so as to conform to any surface, e.g. a parabolic antenna. Optionally the unit cells are provided in a flexible framework of the RIS. The unit cells may be insertable into and removable from corresponding mounting positions, provided in the form of wells or sockets for example, allowing failed unit cells to be replaced manually.

Optionally each mounting position of the flexible framework is flexibly connected to its respective neighboring mounting positions. For example, each mounting position may be connected to its neighboring mounting positions by respective hinges.

Optionally the method further comprises: determining an operational threshold of the first electrical property according to an environment that the RIS operates in; and determining a baseline for the subsequently measured electrical property of the plurality of RIS unit cells based on the determined operational threshold of the first electric property.

Optionally the method further comprises: measuring a stray capacitance of the plurality of RIS unit cells; determining a base line for the subsequently measured electrical property of the plurality of RIS unit cells based on the measured stray capacitance.

Optionally the method further comprises: determining the number of failed unit cells within the RIS; using the number of failed unit cells as a parameter to look up pre-determined settings for each of the plurality of remaining unit cells in order to improve subsequent performance of the RIS. Optionally the method may further comprise determining the distribution of the failed unit cells within the RIS; using the distribution of the failed unit cells as a further parameter to look up the pre-determined settings for each of the plurality of remaining unit cells in order to improve subsequent performance of the RIS. Optionally the predetermined settings are determined using machine learning, wherein the learning phase of the machine learning is performed by varying any one or more of: the first electrical property applied to the unit cells; the number of unit cells that are deactivated; and which of the one or more unit cells are deactivated. Optionally the machine learning is performed based on feedback from a receiver that is arranged to receive a transmission from the RIS, the feedback indicating whether performance of the RIS is improved.

Optionally the method further comprises: turning off one or more unit cells to model one or more failures in the plurality of unit cells; determining a respective performance of a non-planar antenna, the surface of which the RIS is conformed to, based on a configuration of the RIS including the one or more turned-off unit cells; constructing a set of training samples based on a set of combinations of turned-off unit cells and respective performance of the non-planar antenna; training a model, based on the set of training samples, to determine an optimized configuration of the RIS in response to one or more turned-off unit cells; and using the trained model to determine a configuration of the RIS to work without the one or more failed unit cells.

Optionally the method further comprises notifying a controller coupled to the RIS of the determined failure in the one or more unit cells of the plurality of RIS unit cells. The method may then further comprise generating, by the controller, a request for replacement of the one or more failed unit cells and sending the request to a user device or user terminal.

According to a second aspect a RIS is provided comprising a plurality of RIS unit cells and one or more processors configured to carry out any of the methods according to the first aspect and described herein.

According to a third aspect a computer program is provided that, when executed by one or more processors of a RIS system, causes the system to carry out the method of the first aspect.

### BRIEF DESCRIPTION OF THE DRAWINGS

The disclosure will be further described, by way of example only, with reference to the accompanying drawings, in which:

FIG. 1 illustrates schematic diagram 100 showing an exemplary reconfigurable intelligent surface (RIS) conformed on a surface of a dish antenna according to aspects of the disclosure.

FIG. 2a illustrates a schematic illustration 200 of a unit cell of RIS in a top-side view and under-side view and framework wells for holding the unit cells in place according to aspects of the disclosure.

FIG. 2b illustrates an exemplary connections between the unit cell and the corresponding framework well for positioning the unit cell according to aspects of the disclosure.

FIG. 3 illustrates a circuit diagram 300 for monitoring electrical properties of an individual unit cell using a microprocessor according to aspects of the disclosure.

FIG. 4 illustrates a plot 400 of a measurement of the electrical properties of unit cell according to aspects of the disclosure.

FIG. 5 illustrates a flowchart 500 showing operations 501 to 505 of control algorithm and programming phases of the RIS when one or more unit cells report failure or damage according to aspects of the disclosure.

FIG. 6 illustrates different operational modes of using the RIS conformed on a surface of a dish antenna according to aspects of the disclosure.

### DETAILED DESCRIPTION

Embodiments and related technology helpful for understanding and implementing the embodiments will now be described with reference to the Figures. The same or similar reference numerals are used to refer to the same or similar components across different Figures.

A RIS provided according to any embodiment is comprised of unit cells. The unit cells may be subwavelength. For example, the cells may be between one tenth and half a wavelength in size, the wavelength being dependent upon the frequency of operation which, for example, may be radio frequency. Due to the sub-wavelength scale, the surface of the RIS will respond to the incident RF signal as a smoothly varying phase gradient rather than discrete unit cells. The RIS includes a controller that is configured to change the electrical or magnetic properties of individual elements, reducing the amplitude of reflection, shifting the phase change on reflection or the polarization on reflection. The RIS then acts as essentially a reflective phased array.

Optionally, the RIS controller may include a PIN diode or varactor-diode-based programmable metasurface. The aim is generally to enable large phase shifts from each cell while minimizing amplitude shifts, allowing beam control without introducing losses, thereby achieving high antenna gain and wide-angle steering.

An incident RF signal will undergo a phase shift and attenuation upon reflection based on the surface properties of the RIS on a length scale of approximately one RF wavelength. The structure of the RIS immediately below the surface should enable the variation in the surface impedance (e.g. by providing a control voltage to a varactor diode in each unit cell) and should also hold each unit cell in place.

Unit cells are active electronics and at risk of failure and damage. As unit cells fail, the overall performance of the RIS will necessarily degrade. Embodiments may provide a flexible and easily-installed RIS, optionally with inter-changeable unit cells and controllable configurations of the unit cells to achieve a desired performance enhancement for RF communications, which can adapt to compensate for any failure or damage in unit cells during operation.

A flexible and conformal RIS can be placed over a non-planar surface, such as an internal surface of a conventional parabolic dish antenna. In this case, the RIS may be designed to overlay a pre-existing parabolic antenna dish and is constructed from unit cells held in a flexible framework. The design of unit cells' shape, size and distribution will contribute to the frequency response and beam-shaping of the antenna.

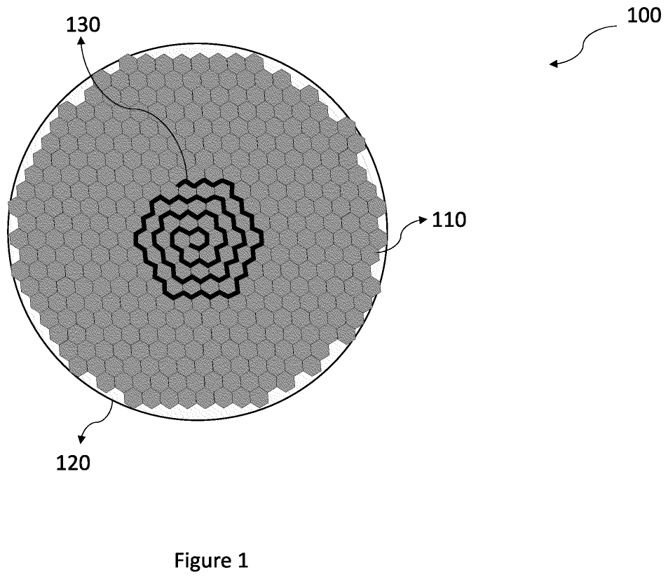

FIG. 1 is a schematic diagram 100 showing an exemplary reconfigurable intelligent surface (RIS) 110 conformed to a non-planar surface 120. The RIS 110 may comprise a plurality of unit cells arranged in a flexible framework.

Optionally an internal wiring pattern 130 may be used, extending out concentrically from the center of the framework. Such a wiring pattern may enable the wiring to be extended for use on larger surfaces, such as larger dishes, and may also ensure ongoing functionality can be preserved in the event of a wiring breakage.

Optionally the flexible framework of RIS 110 may be printed, such as using three-dimensional (3D) printing.

The RIS 110 is conformed to the non-planar surface 120. Conforming to the surface is possible because the RIS is flexible. Such flexibility may be achieved by each of the RIS unit cells being connected to other RIS unit cells in a flexible manner, for example as described below.

In use, the RIS may be positioned between a transmitter and a receiver for wireless RF communications. The RIS may be placed either mid-way between the transmitter and the receiver to overcome a blocked line-of-sight, or close to either the transmitter or receiver in order to minimize path-loss. Generally, the unit cell separation may determine the RF frequency of operation and the controller may determine the reflective characteristics of the surface. In some embodiments, the RIS may also operate in transmission.

Each unit cell of the plurality of unit cells in the RIS may be monitored to determine its ability to change its electrical or magnetic property that causes the change in phase of electromagnetic waves received at the RIS unit cell. This monitoring may be implemented within each unit cell, by a device or controller within the RIS or externally to the RIS.

Optionally each unit cell may be individually swapped out to replace failed unit cells without affecting the rest of the RIS. When one or more failed unit cells are detected, the RIS controller may be notified of the changing distribution of functioning unit cells and optimize the RIS beam-steering accordingly.

A flexible design and configuration of the unit cells in a framework of the RIS is advantageous for achieving the failure detection, reconfiguration and replacement of the unit cells.

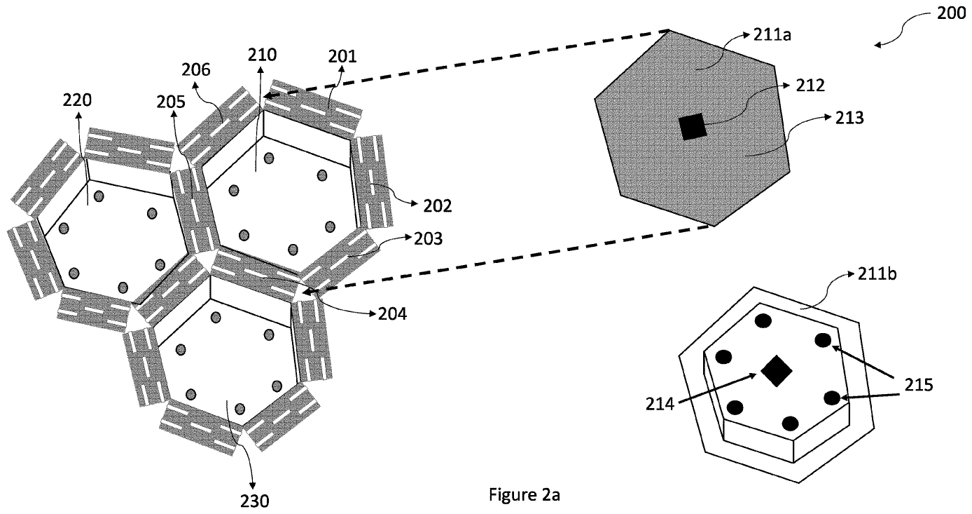

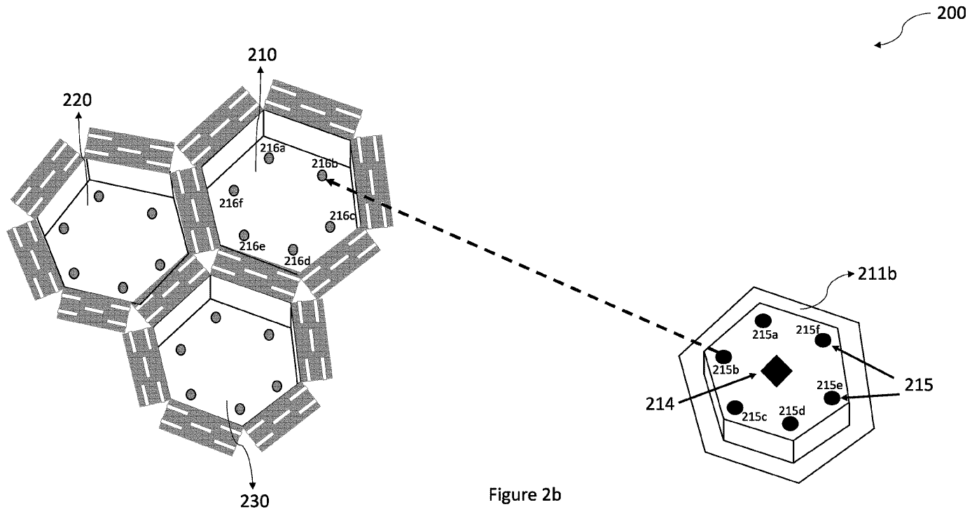

FIGS. 2a and 2b are schematic illustrations showing an example of individual unit cells and a framework for securing corresponding unit cells in place.

The physical support and wiring in the flexible framework are preferably kept distinct from the active electronics in each unit cell. This reduces the complexity and cost of the RIS, as well as making it more rugged and repairable.

Optionally hexagonal-shaped unit cells may be formed in the flexible framework. The hexagonal shape may be selected because it is a convenient form to produce with modern 3D printing methods and offers enough degrees of freedom to fit well on an arbitrary smooth surface, such as following a conformal shape of a pre-existing dish antenna. However, the unit cells and framework may be of any shape other than hexagonal shape.

Optionally, the unit cells may be connected by “living” hinges, also known as integral hinges. For example the hinge may be a thin flexible hinge made from the same material as the two rigid pieces it connects.

FIG. 2a shows an example unit cell 211 when it is viewed from a top side (211a) and from a bottom side (211b). The unit cell 211 may be placed into a well 210 of the flexible framework, wherein the well 210 has two neighboring wells 220 and 230. The well 210 may have more neighboring wells which may not be shown in

FIG. 2a. Each well may be connected to its respective neighboring wells through “living” hinges as described above. As shown in FIG. 2a, the hexagonal well 210 may comprise six hinges, one at each side, namely hinges 201, 202, 203, 204, 205 and 206. The well 210 may be connected to the well 220 through the hinge 205 and may be connected to the well 230 through the hinge 204.

As shown in FIG. 2a, the top-side unit cell 211a may include a diode 212 connected to a patterned conductive surface 213 on a layered dielectric background. In some embodiments, the diode for each unit cell may be a PIN diode or a varactor diode. The bottom-side unit cell 211b may include a microprocessor 214 connected to the unit cell and a plurality of electrical contacts 215 distributed across the bottom side of the unit cell.

The unit cell separation may determine the RF frequency of operation and the controller connected to the plurality of unit cells may determine the reflective characteristics of the surface of the RIS. When in operation, incident RF signals may undergo a phase shift and attenuation upon reflection based on the surface properties of the RIS. Specifically, when an RF signal at an intended wavelength is incident on the unit cells, there may be an oscillating electric field (e.g. referred to as an incident electric field) with a certain magnitude, polarization and phase. The incident RF signal may be reflected by the unit cells which results in a different magnitude, polarization and/or phase. A reflected electric field may then be produced by a movement of the electrons trapped on the surface of the conductive surfaces of the unit cells as they are pushed around the unit cells by the incident electric field. This movement of trapped electrons may be changed by turning on diodes, such that a surface property may be altered and the reflected electric field can be changed.

The surface property of the unit cells may be determined from, and controlled using, an electrical property of the RIS unit cells. The electrical property may be indicative of the change in phase of the reflected electromagnetic waves received at the surface of the RIS. The electrical property may be a surface impedance. The electrical property may, alternatively, be a capacitance, resistance, or inductance of the RIS unit cells. Where capacitance is used the measurement is time dependent, although this is not the case for impedance, resistance or inductance.

Optionally, multiple electrical properties of the RIS can be measured and combined, using weightings for each property, to derive a value indicative of the change in phase of electromagnetic waves received at the RIS unit cell. In such examples, an initial combined value for the plurality of electrical properties of each of the plurality of RIS unit cells is determined, based on predetermined weightings. The combined electrical property value is indicative of the change in phase of electromagnetic waves received at the RIS unit cell. Subsequently the plurality of electrical properties of each of the plurality of RIS unit cells are measured and their combined weighted value is determined. A failure in one or more unit cells of the plurality of RIS unit cells is then determined based on a comparison between the combined measured electrical properties and the combined initial values of the electrical properties. Using such a combined weighted value for comparison may be more accurate than measuring a single value.

It is important that as much of the RIS surface as possible has a controllable surface impedance and is covered by a unit cell. The unit cell's front face may therefore extend over the inset region of the flexible framework, nearly up to a mid-way line of each hinge. In this way the RIS can be both conformal with the non-planar surface (up to the length scale of the unit cells) and also be entirely controllable with semi-continuous unit cells. The small area of exposed supporting framework may be non-reflecting which may simply contribute to a small overall attenuation in reflected power.

FIG. 2b shows an example connection between the unit cell 211 and the corresponding well 210 in the flexible framework. Although the unit cells can be mass-produced and inexpensive, they are nevertheless active electronics and at risk of failure and damage. As unit cells fail, the overall performance of the RIS may necessarily degrade, even if the controller may be able to compensate, since there may be fewer degrees of freedom available to optimize. Each unit cell may therefore be produced with electrical contacts that align with the wiring contacts in the flexible framework so that unit cells can be swapped out in the event of a failure. In some embodiments, the electrical contacts 215 may include electrical contacts 215a, 215b, 215c, 215d, 215e, and 215f. These electrical contacts 215 on the bottom surface of the unit cell 211b may be matched with their corresponding electrical contacts at the inner surface of the well 210. The corresponding electrical contacts of the well 210 may include electrical contacts, 216a, 216b, 216c, 216d, 216e, and 216f.

As shown in FIGS. 2a and 2b, each unit cell includes, or is connected to, a microprocessor 214. The microprocessor may be configured to monitor an electrical property of the RIS, such as surface impedance. In some embodiments, the microprocessor may be configured to measure a capacitance variation of each unit cell in response to an applied voltage. Optionally the microprocessor may measure multiple electrical properties of the RIS and combine these measurements, using weightings for each property, to derive a value indicative of the change in phase of electromagnetic waves received at the RIS unit cell.

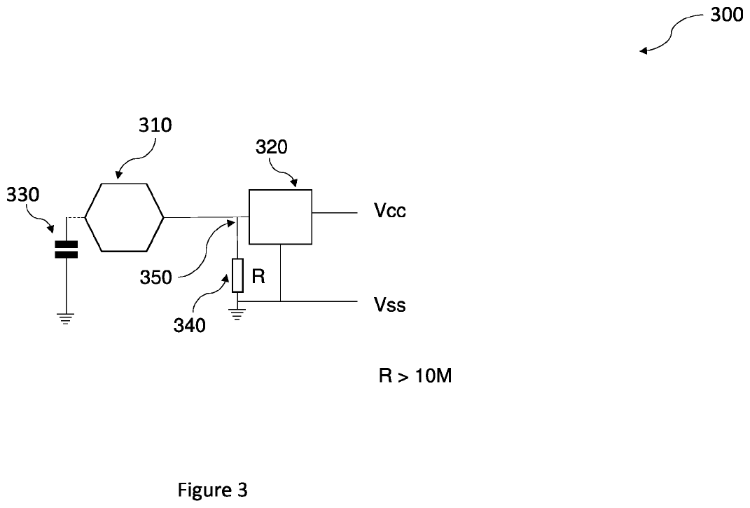

FIG. 3 is a schematic circuit diagram 300 for measuring a capacitance of a unit cell 310. The measurement may be carried out by a microprocessor 320, which may be the microprocessor 214 of FIGS. 2a and 2b. A supply voltage V_{CC} may be applied to the circuit, and a ground V_{SS} may be set correspondingly. The supply voltage V_{CC} may act as a test voltage in order to measure an initial capacitance value of the unit cell 310 as a reference value. For example, the capacitance value may be 1 to 100 pF.

Capacitance values of the unit cell 310 may be small and may be dependent upon a size and a thickness of the unit cell 310 metal patch and the environment the unit cell 310. An operational threshold parameter value may be selected for an environment that the RIS operates in. In some embodiments, the capacitance may be calibrated based on the operational threshold when the RIS is first installed. The operational threshold value for the environment may need to be determined as it is likely dependent upon air humidity and dependent on how much damage to the unit cell can be tolerated. Therefore, the operational threshold of the electrical property of the RIS may be determined, such that the measurement of the electrical property may be calibrated based on the measured operational threshold. In some embodiments, laboratory calibration of the system while it is being designed may provide suitable threshold values and the system itself may run a process or routine to calibrate or baseline itself at time of installation.

In some embodiments, the capacitance of the unit cell 310 may also be calibrated based on a stray capacitance. A stray capacitance 330 may present in the circuit which is an unintended and unwanted capacitance in the circuit. Capacitance does not exist only within capacitors. In fact, any two surfaces at different electric potential that are close enough together to generate an electric field have capacitance, and thus act like a capacitor. The unit cell 310 may therefore have the stray capacitance 330 to its environment. The stray capacitance 330 may be measured as the time when the unit cell 310 remains above a given voltage threshold after it has been charged. The subsequent measurements of capacitance variation of the unit cell 310 may be calibrated based on the measured stray capacitance 330.

In order to measure the capacitance of the unit cell 310, a sense pin 350 may be applied to read a voltage variation. A protective resistor 340 may be connected between the sense pin 350 and the ground V_{SS}. A resistance R of the protective resistor 340 may for example be larger than 10M ohm. When in operation, the microprocessor 320 may monitor the variation in the capacitance of the unit cell based on a comparison between the measured electrical property and the initial value of the electrical property. In some embodiments, the measuring cycles may be carried out periodically in an even time interval.

If during a set of repeating measuring cycles, a response based on the capacitance value of the unit cell 310 no longer falls within the required parameters for operation (e.g. if the conductive surface is scraped off, thus reducing the unit cell's stray capacitance to the environment), a failure may be determined in the unit cell.

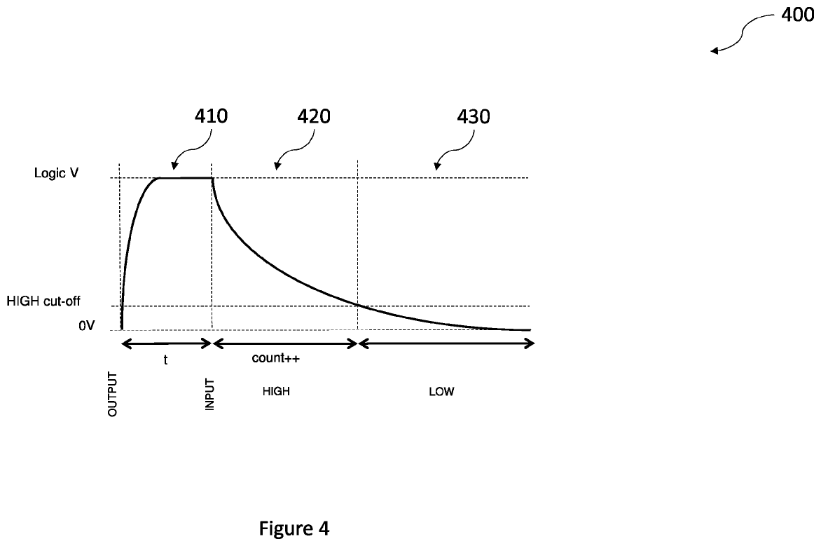

In some embodiments, the microprocessor 320 may monitor the capacitance variation of the unit cell 310 through a change in voltage with respect to time. FIG. 4 shows a graph 400 for the monitoring of such voltage change with respect to time at a number of measuring cycles.

At count=0, the sense pin 350 may be configured to an “OUTPUT” for applying a voltage (logic V) for time t as shown in 410 of FIG. 4. This may correspond to a voltage profile in a charging process. After time t, the sense pin 350 may be configured to an “INPUT” for the following operations at 420 and 430, corresponding to a discharging process. The microprocessor 320 may be configured to include, or control, a voltmeter to measure the capacitance value at each measuring cycle, or at each count. A threshold of the measurement may be predetermined based on the initial value of the capacitance of the unit cell 310 (marked as “HIGH cut-off” in FIG. 4). If the measurement is above the threshold, it may be determined as “HIGH”; if the measurement is below the threshold, it may be determined as “LOW”. At each count, if sense pin 350 reads “HIGH”, the count value may increment. A reference value of count for each unit cell may be calibrated at installation. The count value during monitoring process of the microprocessor 320 may be compared with the reference value. If the monitored count value is lower than the reference count value, it may be determined that the unit cell under monitoring is faulty.

When one or more unit cells are determined to be faulty, the microprocessor 320 may notify the controller. The controller may then modify its control algorithm for the RIS to work without the failed unit cells. The controller may optionally also generate a request for its replacement. The control algorithm for the RIS is further discussed below.

Optionally, suspected damage to the cell by measure of sudden capacitance change could also be corroborated by checking for sudden accelerations, such as high-G loading, detected by any associated accelerometer. This could indicate, for example, that the RIS has been struck by a foreign object.

A key property of a RIS is that it is programmable after deployment. This may be controlled by the controller using a control algorithm. The operation of a RIS can be split into two phases that are executed periodically:
Control and programming phase: the necessary environmental information for configuring the operation of the RIS may be estimated and it may be configured for subsequent operation; and
Normal operation phase: the RIS is already configured and assists the transmission of other devices throughout the network.

In some embodiments, the RIS may be conformed to the dish of a dish antenna for RF communications with a remote satellite. In order to set up the RIS configuration to aid communication between the ground-based satellite dish and the remote satellite, the RIS controller needs to periodically calibrate the status of the RIS itself, communicate with the remote satellite to confirm the results of its configuration and then spend the majority of its time in its normal operation phase.

Conventionally, in order to model the electromagnetic response of an arbitrarily curved metasurface, Maxwell's equations may be applied along boundary conditions by approximating “locally flat” sub regions of the surface. The mathematical feasibility to model the electromagnetic response of an arbitrarily curved metasurface is described by Wu, K., Coquet, P., Wang, Q. J. et al. in “Modelling of free-form conformal metasurfaces”, Nat Commun 9, 3494 (2018), available at https://doi.org/10.1038/s41467-018-05579-6. Such modelling may only be useful for a few tightly controlled special cases, such as lens designs. In practice, a brute force search may be initially used and enhanced by machine-learning and would not need to attempt to model the surface currents within the unit cells.

When each unit cell of the RIS has been overlaid on some arbitrary underlying surface, then an incident plane electromagnetic wave may reach each unit cell with a different and arbitrary phase difference. The challenge is to calculate the phase change that has to be added by each individual unit cell to its small part of the reflected wave so as to orchestrate the summed reflections in the desired wave. For example, a plane wave may be incident from +30 degrees, whereas a reflected beam may be required to reflect off at −45 degrees and come to a focus 3 km away at a remote receiver, using 1000 unit cells overlaid on a surface.

With complete knowledge of the underlying surface, the correct voltage settings required for all the unit cells in order for the RIS to operate as desired could in theory be calculated a priori to get a specific distribution of phase shifts. However, it may be simpler to search through all the different combinations of voltage settings for the unit cells and see what improves the signal strength at the remote receiver. Various search algorithms may be used (e.g. evolutionary or simulated annealing) that will find the voltage settings that are close to optimal for the set of unit cells making up the RIS, given the particular underlying surface, incident wave and remote receiver. This brute force search approach may work but may be slow.

To avoid repeating such a brute force search every time, a “codebook”, or database or table, of sets of voltage settings that have been found to work in the past may be built up and machine learning may be used to identify which starting configuration to be selected for each new situation and then the likely search patterns to use subsequently. A brute force search enhanced by machine-learning may involve initially trying every possible combination of voltage settings to see what settings improve operation and then learning from experience, which may be computationally expensive. Communication with the remote receiver is preferred, at least in an initial training phase and periodically thereafter.

A brute force search enhanced by machine-learning will achieve the desired beam-shaping, so long as a remote receiver can report back to the controller on how each change to the RIS operating parameters affects the received signal during a training phase. This works for directing a beam in a particular direction and also for shaping or steering the radiation pattern. Over time, the machine-learning algorithm will learn which types of voltage patterns result in appropriate operational results such as beam nulls, or tighter main beams, or smaller side lobes. This requires the distribution of functioning unit cells to remain unchanged for much longer than the training period or else the ML technique can not converge on a suitable solution.

So the training phase uses a “brute force” guided search to populate a codebook when the RIS is fully operational. In some embodiments, an extended training phase may be carried out, then alternate codebooks may be generated by deliberately turning off unit cells and repeating the search. The unit cells may be turned off singly, which means turning off one unit cell at a time. The unit cells may also be turned off in combination, which means turning off more than one unit cells at the same time. In this way a whole library of codebooks may be produced corresponding to different potential damage patterns across the RIS. Therefore, different failure situations of the plurality of unit cells in the RIS may be modelled.

It may not be practical to produce a codebook for all possible damage patterns. For example, a 1000 unit cell RIS may have 2¹⁰⁰⁰=10³⁰¹ possible patterns of operating and disabled unit cells. Nevertheless, a further level of machine learning may be used to infer a suitable codebook for any given damage pattern based on a library of learned codebooks using test damage patterns.

Once the training phase is completed and the library of codebooks is assembled, then the normal operation phase may begin. The RIS control algorithm may be triggered when one or more of the unit cell's microprocessors reports a failure. The controller may initially assess the current (presumably deteriorated) performance metrics based on the remote satellite's responses. If no performance deterioration is detected, then no action may be required but the controller may be aware of the current RIS damage pattern. The “post damage but pre-reconfiguration” performance metrics may then be the baseline performance that any RIS reconfiguration needs to improve upon. Using a machine-learning inference based on the reported damage pattern and similar test damage patterns used in the training phase, a new codebook may be generated and applied to the RIS. The controller may then assess the altered (presumably partially) performance metrics based on the remote satellite's responses. If post-reconfiguration performance does not improve, the RIS controller may reset the RIS to its baseline state and attempt a brute force search to attempt to find any new configuration that does produce an improvement. If the post-reconfiguration performance is improved, the RIS controller may use the new configuration.

In parallel to in-operation reconfiguration of the RIS, the RIS controller may also be reporting its ongoing damage pattern and requesting unit cell replacements in specific location on the RIS, for a time when manual replacement is convenient. The radiation pattern or antenna pattern may be the angular dependence of the strength of the radio waves from the antenna dish. The sensitivity as a function of direction of an antenna when used for receiving may be identical to the radiation pattern of the antenna when used for transmitting.

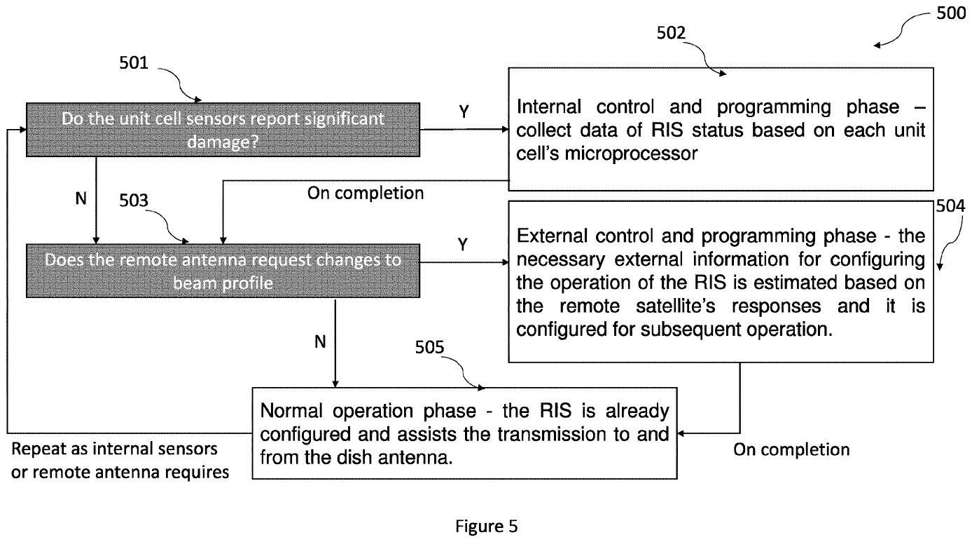

FIG. 5 shows a flowchart 500 which summarizes a method of configuration of the RIS at a control and programming phase, and a normal operation phase taking any failure in unit cells into account. The control and programming phase may be further split into two phases, namely an internal control and programming phase and an external control and programming phase. In the internal control and programming phase, necessary environmental information for configuring the operation of the RIS may be estimated based on each microprocessor of the plurality of unit cells and it is configured for subsequent operation. In the external control and programming phase, the necessary external information for configuring the operation of the RIS may be estimated based on the remote receiver's (e.g. satellite) responses and it is configured for subsequent operation. In the normal operation phase, the RIS is already configured and assists the transmission to and from the dish antenna.

At 501, the controller may be configured to assess any failure or damage in one or more unit cells. If failure or damage is detected, an internal control and programming phase 502 may be carried out to collect data of RIS status based on each microprocessor connected to each unit cell of the plurality of unit cells of the RIS. When such internal programming phase is completed, or there is no failure detected, the controller may be configured to further assess if the remote antenna requests changes to beam profile at a 503. If yes, an external control and programming phase may be carried out at 504. A set of external information for configuring the operation of the RIS may be estimated based on the remote satellite's responses and it may be configured for subsequent operation. When the external programming phase is completed or there is no request for changing the beam profile, a normal operation phase 505 may be then carried out at 505. In this phase, the RIS may be already configured and may assist the communications to and from the dish antenna. The operations at 501 to 505 may be repeated in response to an internal monitoring of the unit cells or a remote request from the antenna.

The method of FIG. 5 is described in relation to communication with a remote satellite, but it may be applied where communication to any appropriate remote transceiver device is implemented.

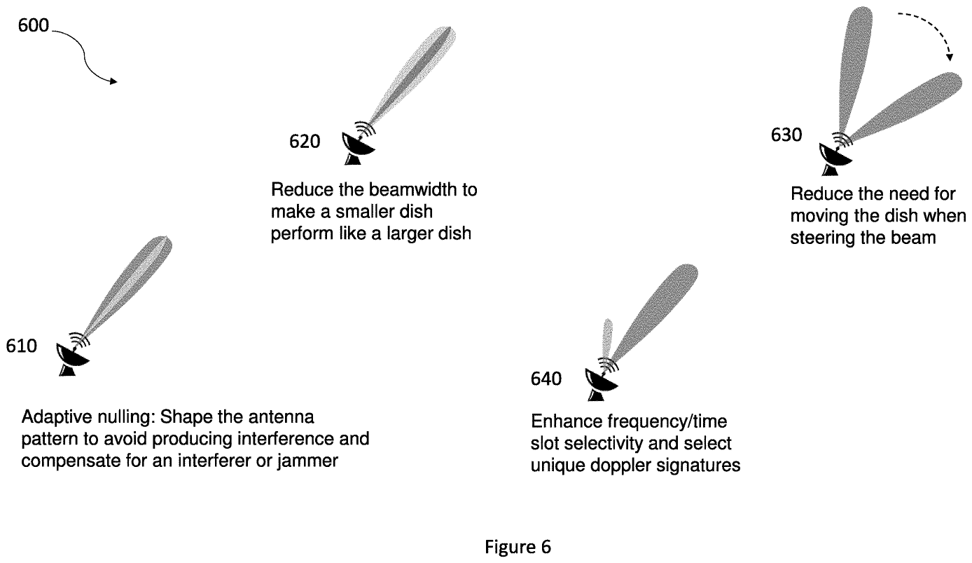

Embodiments can support various distinct performance benefits for a dish antenna. FIG. 6 shows four example advantages that may be achieved with embodiments of the disclosure, namely adaptive nulling, tighter beam with smaller dish, less dish movement, and better selectivity.

With adaptive nulling 610 it is possible to control gaps in the antenna pattern where interference will not be transmitted to or received from, allowing greater density of antennas and improved security against jamming. Adaptive nulling has been successfully used by array antennas to place nulls in the direction of interference sources, thereby minimizing the degradation caused by the interference. The main beam shape, angular locations of the nulls, and the sidelobe level are controlled by precisely setting the phase excitations of each array element. A constrained optimization is used to control the directionality of a single null toward the interfering directions by controlling the phase-only of the element excitations.

As shown in item 620, either the same beam width can be achieved with a smaller dish making it more mobile or pack more densely in a ground station, or the same dish can have a tighter beam with less interference.

Less dish movement 630 can be achieved. The need for dish movement can be reduced or even avoided by using electronic beam steering, to reduce the cost and weight of large dishes. Fine-tuning of angle can be done electronically, with coarse tuning being performed mechanically.

Better selectivity 640 can be achieved. Programmable and adaptive time and frequency-specific gain can be used to distinguish a known satellite with known position and motion from noise and jamming, for improved sensitivity and security.

Although described in relation to a reflective RIS, the embodiments described herein may be applied with any other suitable form of RIS including a transmissive RIS in which the EM wave passes through the RIS and its phase is altered during its passage. For example, a conformal RIS could be a transmissive RIS placed on a non-conducting non-planar surface positioned between the transmitter and receiver.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

Where a processor is referred to herein, this is to be understood to refer to a single processor or multiple processors operably connected to one another. Similarly, where a memory is referred to herein, this is to be understood to refer to a single memory or multiple memories operably connected to one another.

User devices can include, without limitation, static user devices such as PCs and mobile user devices such as smartphones, tablets, laptops and smartwatches.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses. Receivers and transmitters as described herein may be standalone or may be comprised in transceivers. A communication link as described herein comprises at least one transmitter capable of transmitting data to at least one receiver over wireless communication channels.

1. A computer implemented method of detecting failure in a reconfigurable intelligent surface (RIS) that can be conformed to a non-planar surface, the RIS comprising a plurality of RIS unit cells, the method comprising, by one or more processors:
determining an initial value for a first electrical property of each of the plurality of RIS unit cells, the first electrical property being indicative of a change in phase of electromagnetic waves received at the RIS unit cell;
subsequently measuring the first electrical property of each of the plurality of RIS unit cells; and
determining a failure in one or more RIS unit cells of the plurality of RIS unit cells based on a comparison between the measured first electrical property and the initial value of the first electrical property.

2. The method according to claim 1, wherein determining an initial value for the first electrical property of the plurality of RIS unit cells is based on a measurement of the first electrical property in response to an applied test voltage.

3. The method according to claim 1, wherein the first electrical property is an electrical impedance, a capacitance, a resistance, or an inductance of the RIS unit cell.

4. The method according to claim 1, the method further comprising:
determining an operational threshold of the first electrical property according to an environment that the RIS operates in; and
determining a baseline for the subsequently measured first electrical property of the plurality of RIS unit cells based on the determined operational threshold of the first electric property.

5. The method according to claim 1, the method further comprising:
measuring a stray capacitance of the plurality of RIS unit cells; and
determining a base line for the subsequently measured first electrical property of the plurality of RIS unit cells based on the measured stray capacitance.

6. The method of claim 1, the method further comprising:
determining a number of failed RIS unit cells within the RIS; and
using the number of failed RIS unit cells as a parameter to look up predetermined settings for each of a plurality of remaining RIS unit cells in order to improve subsequent performance of the RIS.

7. The method of claim 6, further comprising:
determining a distribution of the failed RIS unit cells within the RIS; and
using the distribution of the failed RIS unit cells as a further parameter to look up the predetermined settings for each of the plurality of remaining RIS unit cells in order to improve subsequent performance of the RIS.

8. The method of claim 6, wherein the predetermined settings are determined using machine learning.

9. The method of claim 8, wherein a learning phase of the machine learning is performed by varying any one or more of:
the first electrical property applied to the RIS unit cells;
a number of RIS unit cells that are deactivated; and
which of the RIS unit cells are deactivated.

10. The method of claim 8, wherein the machine learning is performed based on feedback from a receiver that is arranged to receive a transmission from the RIS, the feedback indicating whether performance of the RIS is improved.

11. The method according to claim 1, the method further comprising:
turning off one or more RIS unit cells to model one or more failures in the plurality of RIS unit cells;
determining a respective performance of a communication system comprising the RIS based on a configuration of the RIS including the one or more turned-off RIS unit cells;
constructing a set of training samples based on a set of combinations of turned-off RIS unit cells and respective performance of the communication system comprising the RIS;
training a model, based on the set of training samples, to determine an optimized configuration of the RIS in response to one or more turned-off RIS unit cells; and
using the trained model to determine a configuration of the RIS to work without the one or more failed RIS unit cells.

12. The method according to claim 1, the method further comprising:
notifying a controller coupled to the RIS of the determined failure in the one or more RIS unit cells of the plurality of RIS unit cells.

13. The method of claim 1, wherein each of the RIS unit cells are connected to a plurality of other RIS unit cells in a flexible manner.

14. A reconfigurable intelligent surface (RIS) that can be conformed on to a non-planar antenna surface, the RIS comprising a plurality of RIS unit cells and one or more processors configured to carry out the method of claim 1.

15. A non-transitory computer-readable storage medium storing a computer program that, when executed by one or more processors of a reconfigurable intelligent surface (RIS) system, causes the system to carry out the method of claim 1.
